(19) United States
(12) Patent Application Publication
(10) Pub. No.: US 2013/0017241 A1
(43) Pub. Date: Jan. 17, 2013

(54) Encapsulated Chlorine Dioxide Generator

(71) Applicants: Kim Andrews, Ontario (CA); Shaukat Ali, Monmouth Juntion, NJ (US); Jesse Jefferis, Wayne, MI (US); James S. Dailey, Grosse Ile, MI (US); Charles O. Onyiuke, Mt. Arlington, NJ (US); Keith A. Hirsch, Canton, MI (US)

(72) Inventors: Kim Andrews, Ontario (CA); Shaukat Ali, Monmouth Juntion, NJ (US); Jesse Jefferis, Wayne, MI (US); James S. Dailey, Grosse Ile, MI (US); Charles O. Onyiuke, Mt. Arlington, NJ (US); Keith A. Hirsch, Canton, MI (US)

(73) Assignee: BASF SE, Ludwigshafen (DE)

(21) Appl. No.: 13/576,611

(22) PCT Filed: Feb. 1, 2011
(86) PCT No.: PCT/US11/23334

§ 371 Date: Oct. 3, 2012

Related U.S. Application Data
(60) Provisional application No. 61/300,724, filed on Feb. 2, 2010.

(51) Int. Cl. A01N 25/26; A01P 1/00; B05D 1/02; A01N 59/00

(52) U.S. Cl. 424/405; 424/497; 424/661; 424/76.1; 424/76.8; 427/2.14

(57) ABSTRACT

An encapsulated chlorine dioxide generator is provided. The encapsulated generator includes a core particle that includes a metal chlorite and a solid acid. The encapsulated generator also includes a protective layer that is disposed about at least a portion of the core particle. The protective layer includes a copolymer of polyvinyl alcohol and a polyalkylene glycol. The encapsulated generator is formed in a method including the steps of forming the core particle and disposing the protective layer about the core particle. The encapsulated generator is also used in a method of cleaning an environment. The method of cleaning the environment includes the steps of providing the encapsulated generator and forming chlorine dioxide from the encapsulated chlorine dioxide generator to clean the environment.

### FIELD OF THE INVENTION

The subject invention generally relates to an encapsulated chlorine dioxide generator. More specifically, the encapsulated chlorine dioxide generator includes a core particle and a protective layer that is disposed about at least a portion of the core particle and that includes a copolymer of polyvinyl alcohol and a polyalkylene glycol.

### DESCRIPTION OF THE RELATED ART

Chlorine dioxide (ClO₂) is a potent biocide, germicide, and deodorizing agent that is typically generated by exposure of a combination of a chlorite and an acid to moisture, e.g. atmospheric moisture and/or liquid water. Chlorine dioxide is typically used in low concentrations (i.e., in concentrations of up to 1,000 ppm) for disinfecting and deodorizing surfaces, for disinfecting municipal water supplies, and in numerous other applications. In fact, chlorine dioxide is characterized by the Environmental Protection Agency (EPA) as an effective biocide over a wide pH range at 25 parts per million (ppm) at 20° C. when exposed to a surface for 1 minute. Typically, chlorine dioxide does not form chlorinated molecules in the presence of organics and does not chlorinate water or surfaces but instead works as a biocide through oxidation and penetration of bacterial cell walls to react with amino acids therein.

According to the EPA, chlorine dioxide is a volatile gas that can be toxic to humans at concentrations greater than 1,000 ppm. In addition, chlorine dioxide is combustible at pressures greater than about 0.1 atmospheres. Therefore, chlorine dioxide is typically manufactured on-site and is not usually shipped under pressure. Conventional methods of on-site manufacture require not only expensive generation equipment but also high levels of operator skill to avoid production problems. These problems substantially limit use of chlorine dioxide to large commercial applications where the consumption of chlorine dioxide is sufficiently large that it justifies the expenditure of capital and operating costs associated with on-site manufacturing.

Furthermore, on-site manufacture of chlorine dioxide is not appropriate for small-scale operations where mixing and handling of hazardous chemicals is not desired or feasible. Moreover, if the chlorine dioxide is generated from a mixture of chlorites and acids, there is an increased possibility of premature release of chlorine dioxide upon exposure to moisture during storage and/or shipping. Accordingly, these types of mixtures typically suffer from reduced storage stability and require expensive packaging to shield the mixtures from moisture, to minimize premature release of chlorine dioxide, and to extend shelf life.

In response to a need for more convenient methods of producing chlorine dioxide, solid chlorine dioxide generators have been formulated. Many of these solid chlorine dioxide generators form chlorine dioxide upon exposure to moisture or upon contact with liquid water and are typically sold as uncoated tablets, as generically shown in FIG. 1. Although effective in forming chlorine dioxide upon demand, these generators may pre-maturely release chlorine dioxide upon exposure to moisture during shipping and storage, thereby decreasing shelf life and increasing shipping costs. In addition, these generators can be friable and break apart during shipping and handling, thus further reducing shelf life and further complicating shipping methods.

Accordingly, there remains an opportunity to develop an improved and cost- effective chlorine dioxide generator. There also remains an opportunity to develop a method of forming and utilizing the improved chlorine dioxide generator.

### SUMMARY OF THE INVENTION AND ADVANTAGES

The instant invention provides an encapsulated chlorine dioxide generator. The encapsulated generator includes a core particle that includes a metal chlorite and a solid acid. The encapsulated generator also includes a protective layer disposed about at least a portion of the core particle. The protective layer includes a copolymer of polyvinyl alcohol and a polyalkylene glycol. The encapsulated generator is formed via a method that includes the step of forming the core particle and the step of disposing the protective layer about the core particle. The encapsulated generator is utilized in a method of cleaning an environment wherein the method includes the steps of providing the encapsulated generator and forming chlorine dioxide from the encapsulated chlorine dioxide generator to clean the environment.

The protective layer provides a moisture barrier for the core particle. This protective layer reduces permeability of water to the core particle thereby enhancing both storage and shipping stability of the encapsulated generator and extending shelf life. This reduced permeability also increases ease and convenience of use due to an ability to expose the encapsulated generator to ambient temperature and humidity for extended periods of time without the premature formation and release of chlorine dioxide. However, the protective layer simultaneously allows the encapsulated generator to dissolve in water and thus produce chlorine dioxide upon demand and under desired conditions.

### BRIEF DESCRIPTION OF THE SEVERAL VIEWS OF THE DRAWINGS

Other advantages of the present invention will be readily appreciated, as the same becomes better understood by reference to the following detailed description when considered in connection with the accompanying drawings wherein:

FIG. 1 is a perspective view of a chlorine dioxide generator of the prior art in the form of a tablet without the protective layer of the instant invention;

FIG. 2A is a perspective view of an encapsulated chlorine dioxide generator including a core particle in the form of a tablet and also including the protective layer of the instant invention disposed about at least a portion of the core particle;

FIG. 2B is a top view of the encapsulated chlorine dioxide generator of FIG. 2A;

FIG. 2C is a partially cut-away view of the encapsulated chlorine dioxide generator of FIG. 2A;

FIG. 3A is a perspective view of an encapsulated chlorine dioxide generator including the core particle in the form of a tablet, including the protective layer of the instant invention disposed about at least a portion of the core particle, and also including a second protective layer simultaneously disposed on the protective layer and disposed about at least a portion of the core particle;

FIG. 3B is a top view of the encapsulated chlorine dioxide generator of FIG. 3a;

FIG. 4 is a cross-sectional view of an encapsulated chlorine dioxide generator including the core particle in the form of a capsule and also including the protective layer of the instant invention disposed about at least a portion of the core particle;

FIG. 5 is a cross-sectional view of an encapsulated chlorine dioxide generator including the core particle in the form of a capsule, including the protective layer of the instant invention disposed about at least a portion of the core particle, and also including a second protective layer simultaneously disposed on the protective layer and disposed about at least a portion of the core particle;

FIG. 6 is a cross-sectional view of an encapsulated chlorine dioxide generator including the core particle in the form of a capsule, including the protective layer of the instant invention disposed about at least a portion of a first portion of the core particle, and also including a second protective layer disposed about at least a portion of a second portion of the core particle;

FIG. 7 is a cross-sectional view of an encapsulated chlorine dioxide generator including the core particle in the form of a capsule and including the protective layer of the instant invention disposed about at least a portion of a portion of the core particle;

FIG. 8 is a cross-sectional view of an encapsulated chlorine dioxide generator including the core particle in the form of a capsule, including the protective layer of the instant invention disposed about at least a portion of portion of the core particle, and also including a second protective layer disposed on the protective layer about the same portion of the core particle;

FIG. 9A is a schematic generally illustrating the disintegration of the Comparative Tablets I of the Examples which include the core particle and a protective (comparative) layer that is disposed about the core particle and that includes ethyl cellulose but is not representative of the instant invention;

FIG. 9B is an enlarged view of the non-disintegrated Comparative Tablets I of FIG. 9A;

FIG. 9C is an enlarged view of the disintegrated Comparative Tablets I of FIG. 9A;

FIG. 10A is a schematic generally illustrating the disintegration of the Comparative Tablets II of the Examples which include the core particle and a protective (comparative) layer that is disposed about the core particle and that includes polyvinyl acetate but is not representative of the instant invention;

FIG. 10B is an enlarged view of the disintegrated Comparative Tablets II of FIG. 10A;

FIG. 11A generally illustrates the Tablets III, IV, V, VI, and VII of the Examples;

FIG. 11B is an enlarged view of the Tablets III of FIG. 11A which include approximately 9 parts by weight of the protective layer per 100 parts by weight of uncoated tablets and wherein the protective layer has a thickness of approximately 111 μm;

FIG. 11C is an enlarged view of the Tablets IV of FIG. 11A which include approximately 10 parts by weight of the protective layer per 100 parts by weight of uncoated tablets and wherein the protective layer has a thickness of approximately 120 μm;

FIG. 11D is an enlarged view of the Tablets V of FIG. 11A which include approximately 12 parts by weight of the protective layer per 100 parts by weight of uncoated tablets and wherein the protective layer has a thickness of approximately 147 μm;

FIG. 11E is an enlarged view of the Tablets VI of FIG. 11A which include approximately 12.5 parts by weight of the protective layer per 100 parts by weight of uncoated tablets and wherein the protective layer has a thickness of approximately 159 μm;

FIG. 11F is an enlarged view of the Tablets VII of FIG. 11A which include approximately 15 parts by weight of the protective layer per 100 parts by weight of uncoated tablets and wherein the protective layer has a thickness of approximately 199 μm; and

FIG. 12 generally illustrates various thicknesses of the protective layer disposed about at least a portion of the core particle at points (A-H).

### DETAILED DESCRIPTION OF THE INVENTION

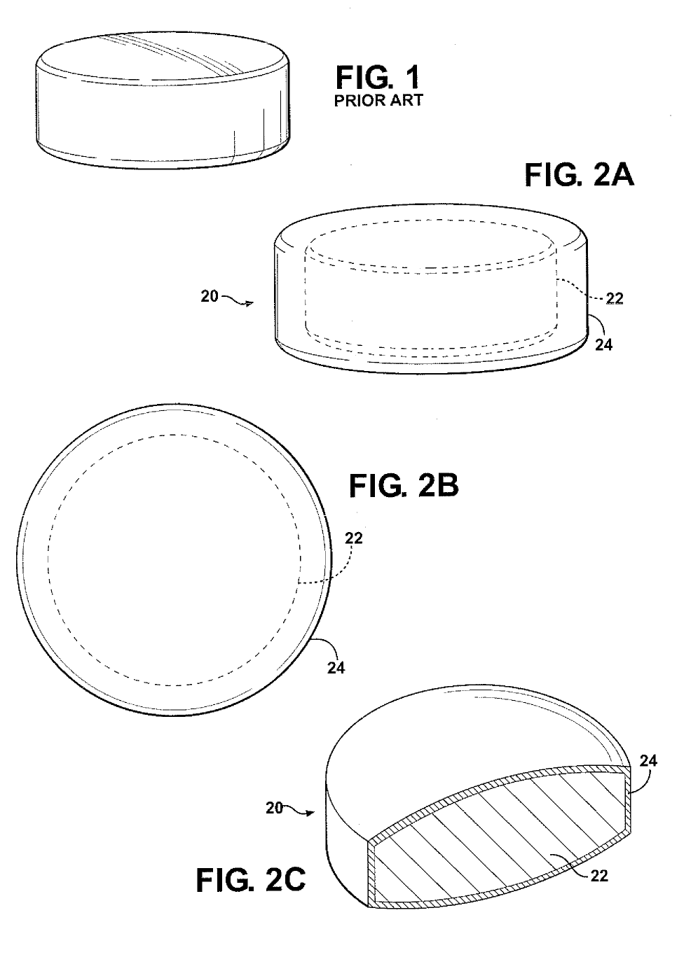

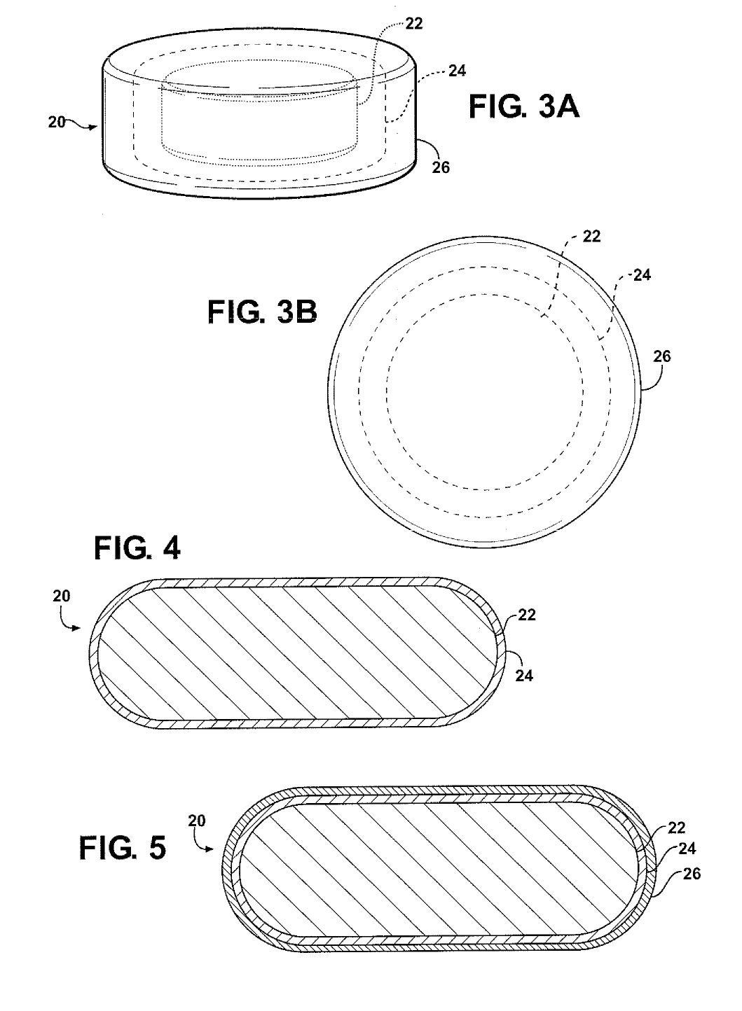

The present invention provides an encapsulated chlorine dioxide (ClO₂) generator (20) (hereinafter referred to as an “encapsulated generator”), as shown in FIGS. 2-8, 11, and 12. The encapsulated generator (20) includes a core particle (22), as also shown in FIGS. 2-8, 11, and 12. The core particle (22) is typically a solid but may be gel-like. Alternatively, the core particle (22) may have both solid portions and gel-like portions. In one embodiment, the core particle (22) is a tablet, as shown, for example, in FIGS. 2 and 3. In other embodiment, the core particle (22) is a capsule or caplet, as shown, for example, in FIGS. 4-8. In still other embodiments, the core particle (22) is selected from the group of briquettes, pills, pellets, bricks, sachets, and combinations thereof. In one embodiment, the core particle (22) is further defined as a “massive body” which, as is known in the art, refers to a solid shape (typically a porous solid shape) that includes a mixture of particulates. The core particle (22) is not limited in shape, size, or mass. In various embodiments, the core particle (22) is a tablet that has a weight of from about 375 to 400 mg, of about 700 mg, of from about 375 to 850 mg, of from about 850 mg to 1000 g, of from about 1.2 to 1.5, grams, of about 6 grams, or of about 8.33 grams. However, it is also contemplated that smaller or larger tablets can be used. In one embodiment, the core particle (22) is one or more granules that have a size of less than 6 mesh but greater than 10 mesh. In various embodiments, it is contemplated that one or more of the aforementioned values may be any value or range of values, both whole and fractional, within the aforementioned ranges and/or may vary by ±5%, ±10%, ±15%, ±20%, ±25%, ±30%, etc.

The core particle (22) includes a metal chlorite (e.g. MClO₂ or M(ClO₂)₂) and a solid acid (HA). One or both of the metal chlorite and the solid acid may independently be particulate, granular, or coarse. Alternatively, one or both of the metal chlorite and the solid acid may be fine powders or particles. It is also contemplated that one or both of the metal chlorite and the solid acid may be gel-like. A suitable but non-limiting example of a core particle (22) of this invention is commercially available from BASF Corporation under the trade name of Aseptrol® which includes both the metal chlorite and the solid acid.

The metal chlorite and the solid acid are included in the core particle (22) to react to form the chlorine dioxide. As is known in the art, the solid acid reacts with water (e.g. liquid and/or water vapor) to form hydrogen ions (H⁺) and hydronium ions (H₃O⁺). The H⁺/H₃O⁺ ions typically react with the metal chlorite to produce chlorous acid (HClO₂) and metal ions (M⁺) as in the following chemical reaction:

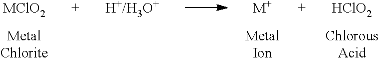

After chlorous acid is formed, chlorine dioxide is typically produced via disproportionation of chlorous acid and/or via oxidation of chlorous acid. The disproportionation of chlorous acid to chlorine dioxide typically occurs via the following chemical reaction:
5 HClO₂→4 ClO₂+HCl+2 H₂O
   The oxidation of chlorous acid typically occurs via the following chemical reaction:
HClO₂→ClO₂+H³⁰
   Accordingly, if both disproportionation and oxidation occur, the reaction of the metal chlorite and the solid acid typically proceeds as follows:
5 MClO₂+4 HA→4 MA+MCl+4ClO₂+2 H₂O
   In various embodiments, the formation of chlorine dioxide occurs according to using one or more of the following reactions:
5 NaClO₂+4 H⁺4 →ClO₂+NaCl+4Na⁺+2 H₂O
   2 NaClO₂+HOCl→2 ClO₂+NaCl+NaOH

The metal chlorite typically includes an alkali metal and/or an alkaline earth metal (e.g. Na, K, Rb, Mg, Ca, Sr). In one embodiment, the metal chlorite is further defined as sodium chlorite (NaClO₂). In another embodiment, the metal chlorite is further defined as potassium chlorite (KClO₂). In still another embodiment, the metal chlorite is selected from the group of magnesium chlorite Mg(ClO₂)₂, calcium chlorite Ca(ClO₂)₂, and combinations thereof. Of course, the instant invention is not limited to these particular embodiments and may include any metal chlorite known in the art, any of the metal chlorites described above, and/or one or more metal chlorites selected from the group of transition metal chlorites, group IB, IIB, IIIA, IVA, VA, and/or VIA metal chlorites, and combinations thereof. Metal chlorates, MClO₃ or M(ClO₃)₂, of the aforementioned metals may also be used.

The solid acid typically includes one or more of inorganic acid salts, such as sodium acid sulfate (NaO₄SH), potassium acid sulfate (KO₄SH), sodium dihydrogen phosphate (NaO₄PH₂), and potassium dihydrogen phosphate (KO₄PH₂), salts including anions of strong acids and cations of weak bases, such as aluminum chloride (AlCl₃), aluminum nitrate (AlN₃O₉), cerium nitrate (CeN₃O₉), and iron sulfate (Fe₂O₁₂S₃), solid acids that can liberate protons into solution when contacted with water, such as a mixture of an acid ion exchanged molecular sieve ETS-10 and sodium chloride, organic acids, such as citric acid and tartaric acid, and combinations thereof. Most typically, the solid acid is further defined as sodium bisulfate (NaHSO₄). Of course, the instant invention is not limited to the aforementioned solid acids and may include any solid compound that is capable of producing H⁺/H₃O⁺ ions in solution.

The core particle (22) may also include a metal hypochlorite (e.g. MClO or M(ClO)₂) such as an alkali hypochlorite and/or an alkaline earth metal (e.g. Na, K, Rb, Mg, Ca, Sr) hypochlorite. In various embodiments, the core particle (22) includes sodium hypochlorite (NaClO) and/or potassium hypochlorite (KClO). In other embodiments, the core particle (22) includes magnesium hypochlorite (Mg(ClO)₂) and/or calcium hypochlorite (Ca(ClO)₂). Just as above, the instant invention is not limited to these particular embodiments and may include any metal hypochlorite known in the art, any of the metal hypochlorites described above, and/or one or more metal hypochlorites selected from the group of transition metal chlorites, group IB, IIB, MA, IVA, VA, and/or VIA metal hypochlorites, and combinations thereof. Without intending to be bound by any particular theory, it is believed that when the core particle (22) includes one or more metal hypochlorites, formation of chlorine dioxide may proceed as follows:
2 MClO₂+2 HA+MClO→2 MA+MCl+2ClO₂+H₂O

The core particle (22) may also include a free halogen (e.g. a source of the free halogen). Suitable examples of compounds that provide free halogens include, but are not limited to, dichloroisocyanuric acid and salts thereof such as sodium dichloroisocyanurate (NaDCCA; NaC₃Cl₂N₃O₃), and/or dihydrates thereof, trichlorocyanuric acid, salts of hypochlorous acid such as sodium, potassium and calcium hypochlorite, bromochlorodimethylhydantoin, dibromodimethylhydantoin and the like. A preferred source of the free halogen is NaDCCA.

In additional embodiments, the core particle (22) includes one or more additives. The additives may be included to improve efficiency of producing the core particle (22), to improve physical and/or aesthetic characteristics of the core particle (22), and/or to increase reaction efficiency of the metal chlorite and solid acid to form the chlorine dioxide. The additives may include, but are not limited to, fillers such as clay (e.g. attapulgite clay) and sodium chloride, tabletting and tablet die lubricants, stabilizers, dyes, anti-caking agents, desiccating filling agents such as calcium chloride and magnesium chloride, pore forming agents such as swelling inorganic clay (e.g. Laponite clay), effervescing agents, and combinations thereof.

In one embodiment, the core particle (22) includes a substrate. The metal chlorite and the solid acid may be disposed on or in the substrate. In one embodiment, the substrate is further defined as a framework former. Framework formers are typically used as low-solubility porous structures in which chlorine dioxide forming reactions (i.e., reactions between the metal chlorite and the solid acid) may proceed. The framework formers typically include a low-solubility salt such as calcium sulfate (Gypsum) and may additionally include a clay such as Laponite clay. The calcium sulfate is typically formed from a reaction between calcium cations (e.g. from calcium chloride and from sulfate anions derived from sodium bisulfate). Other sources of calcium cations such as calcium nitrate as well as other sources of sulfate anions such as magnesium sulfate may also be used. Laponite clay is a water-insoluble swelling clay which is thought to enhance the low-solubility porous structure. In one embodiment, a calcium sulfate framework is formed in-situ via a chemical reaction.

If the core particle (22) includes a framework former, the framework former typically remains substantially undissolved in solution during a period of chlorine dioxide production. In most cases, visual inspection, mass balance, and/or various analytical techniques can be used to determine if any of the framework former remains substantially undissolved, i.e., does not go into solution. It is not necessary that the framework former remain wholly intact during the period of chlorine dioxide production. In fact, in one embodiment, the core particle (22) is further defined as a tablet that disintegrates into substantially insoluble (or slowly soluble) granules that release chlorine dioxide into solution. Without intending to be bound by any particular theory, it is believed that an overall size of the granules is large relative to a pore size of the granules, such that suitable reaction conditions exist within the pores to form chlorine dioxide.

In one embodiment, the core particle (22) defines a plurality of pores in the porous framework structure described above. The pores may be of any size and shape. While not wishing to be bound by any particular theory, it is believed that a maximized yield of chlorine dioxide is produced from the core particle (22) when the core particle (22) is exposed to water and the water enters the pores of the core particle (22). In one embodiment, a concentrated acidic solution of chlorite anion is formed within the pores from reaction of the solid acid and the metal chlorite in the pores.

It is also theorized that little or no chlorine dioxide is formed when the metal chlorite and solid acid are in powder form and the powder is rapidly dissolved in water. In fact, an increased conversion rate of the metal chlorite to chlorine dioxide is typically obtained when the core particle (22) defines the pores and when the metal chlorite and the solid acid react within the pores. Said differently, substantially all of the chlorite anion has an opportunity to react and form chlorine dioxide under favorable conditions within the pores. This is thought to maximize chlorite conversion to chlorine dioxide. A conversion ratio of chlorite anion to chlorine dioxide is typically greater than 0.25, more typically greater than 0.50, and most typically greater than 0.90. The terminology “conversion ratio” refers to a calculated ratio of free chlorine dioxide concentration in the water to a sum of free chlorine dioxide concentration plus non-reacted chlorite ion concentration in the water. In one embodiment, the water has a generally neutral pH (i.e., pH 5-9) when the chlorine dioxide is formed. In various embodiments, it is contemplated that one or more of the aforementioned values may vary by ±5%, ±10%, ±15%, ±20%, ±25%, ±30%, etc.

The metal chlorite and the solid acid source typically react with water to form a solution comprising chlorine dioxide and a chlorite anion. In one embodiment, the chlorine dioxide and the chlorite anion are present in a ratio of greater than 0.25:1, by weight. In an alternative embodiment, the metal chlorite and the solid acid source react with water to form a solution comprising chlorine dioxide, the chlorite anion, and a free halogen. The concentration of free halogen in the solution is typically less than a concentration of chlorine dioxide in the solution on a weight basis. In another embodiment, a ratio of the concentration of chlorine dioxide in the solution to a sum of the concentration of chlorine dioxide and a concentration of chlorite anion in the solution, is at least 0.25:1 by weight. In yet another embodiment, this ratio is at least 0.50:1 by weight. In still another embodiment, this ratio is at least 0.75:1 by weight. In another embodiment, this ratio is at least 0.90:1 by weight. In an alternative embodiment, the concentration of the free halogen in the solution is at least equal to a concentration of chlorine dioxide in the solution on a weight basis. In another alternative embodiment, the concentration of free halogen in the solution is less than ½ of the concentration of chlorine dioxide in the solution on a weight basis. In yet another alternative embodiment, the concentration of free halogen in the solution is less than ¼ of the concentration of chlorine dioxide in the solution on a weight basis. In still another alternative embodiment, the concentration of free halogen in the solution is less than 1/10 of the concentration of chlorine dioxide in the solution on a weight basis. In various embodiments, it is contemplated that one or more of the aforementioned values may vary by ±5%, ±10%, ±15%, ±20%, ±25%, ±30%, etc.

It is also contemplated that the core particle may be further defined as set forth in one or more of U.S. Pat. Nos. 6,432,322, 6,676,850, 6,699,404, 7,150,854, and/or 7,182,883, each of which is expressly incorporated herein by reference.

In addition to the core particle (22), the encapsulated generator (20) also includes a protective layer (24) disposed about at least a portion of the core particle (22). It is to be understood that the terminology “disposed about” encompasses both partial and complete covering of the core particle (22) by the protective layer (24). In one embodiment, the protective layer (24) completely encompasses the core particle (22), as set forth in FIGS. 2-6. In another embodiment, the protective layer (24) only partially encompasses the core particle (22), as set forth in FIGS. 7 and 8. Typically, the protective layer (24) is disposed on and in direct contact with the core particle (22). Also, the protective layer (24) is typically an outermost layer of the encapsulated generator (20). However, the protective layer (24) may be an inner layer of the encapsulated generator (20).

The protective layer (24) improves the hardness and durability of the encapsulated generator (20) while simultaneously reducing friability during transport and use. This preserves the integrity of the encapsulated generator (20) when sold, and minimizes costs associated with replacement of fractured product. Furthermore, the protective layer (24) typically provides an excellent finish and glossy appearance to the encapsulated generator (20). Even further, the copolymer of the protective layer (24) does not require peroxide initiation for formation thereby minimizing any oxidation and premature decomposition of the encapsulated generator (20) that residual peroxides may otherwise cause.

The protective layer (22) is typically present in an amount of from 0.1 to 20, more typically in an amount of from 1 to 15, still more typically in an amount of from 3 to 15, and even more typically present in an amount of from 3 to 5, parts by weight per 100 parts by weight of the core particle (22). In various embodiments, the protective layer (22) is present in an amount of from 3 to 6, from 3 to 7, from 3 to 8, from 3 to 9, from 3 to 10, from 3 to 11, from 3 to 12, from 3 to 13, from 3 to 14, from 9 to 12, or from 9 to 15, parts by weight per 100 parts by weight of the core particle (22). Of course, the protective layer (24) is not limited to the aforementioned amounts and ranges. In various embodiments, it is contemplated that one or more of the aforementioned values may be any value or range of values, both whole and fractional, within the aforementioned ranges and/or may vary by ±5%, ±10%, ±15%, ±20%, ±25%, ±30%, etc.

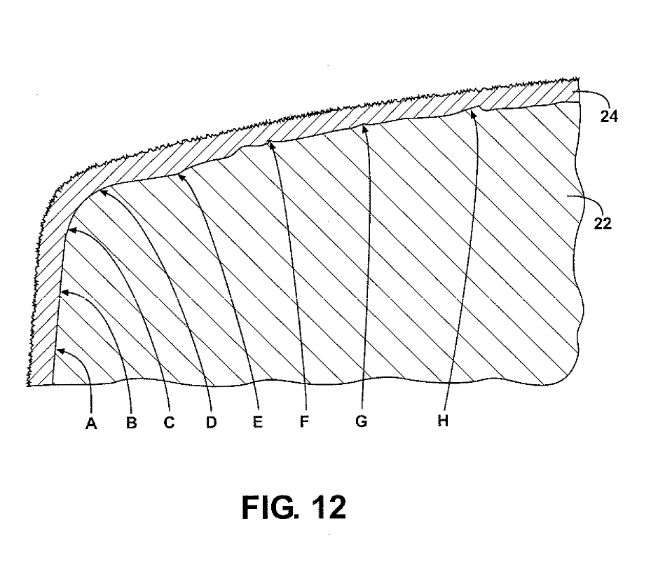

The protective layer (24) may have any thickness but typically has a thickness of from 85 to 210 micrometers. As shown in FIG. 12, the protective layer (24) may have varying thicknesses at differing points (A-H) of the encapsulated generator (20). In various embodiments, the protective layer (24) has thicknesses as set forth below in micrometers wherein the “side” corresponds approximately to point B in FIG. 12, wherein the “corner” corresponds approximately to point D in FIG. 12, and wherein the “top” corresponds approximately to point F in FIG. 12.

| Approx. | Side | Corner | Top | Average |
|---|---|---|---|---|
| Weight Percent of | Thickness | Thickness | Thickness | Thickness |
| Protective Layer (24) | (μm) | (μm) | (μm) | (μm) |
| 15 | 209 | 188 | 195 | 199 |
| 12.5 | 160 | 145 | 162 | 159 |
| 12 | 138 | 135 | 157 | 147 |
| 10 | 119 | 98 | 127 | 120 |
| 9 | 101 | 86 | 125 | 111 |

It is contemplated that in various embodiments, one or more of the thicknesses described above may vary by ±5%, 10%, 15%, 20%, or more. It is also contemplated that the protective layer (24) may have a uniform thickness at one or more points of the encapsulated generator (20) or at all or almost all points of the encapsulated generator (20). Alternatively, the protective layer (24) may be uniform at some points and vary in thickness at other points of the encapsulated generator (20). The instant invention is not limited by the aforementioned thicknesses as the protective layer (24) may have any thickness. Also, the instant invention is not limited to the thicknesses described above as specifically related to the approximate weight percentages. Said differently, the protective layer (24) may have one or more of the aforementioned thicknesses, or any thickness at all, at any one or more of the aforementioned approximate weight percentages or at different weight percentages than those described above.

The protective layer (24) includes a copolymer of polyvinyl alcohol and a polyalkylene glycol. Typically, the copolymer is further defined as a graft copolymer of the polyvinyl alcohol and the polyalkylene glycol. As is known in the art, polyvinyl alcohol has the following chemical structure wherein n is a number greater than one:

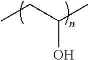

Typically, the polyvinyl alcohol used to form the copolymer has a viscosity of about 30,000 cps measured at room temperature. However, the instant invention is not limited to such a viscosity. Polyvinyl alcohols having higher viscosities (e.g. up to about 130,000 cps or up to about 200,000 cps) can be utilized. The polyvinyl alcohol also typically has a weight average molecular weight of from 30,000 to 200,000, more typically of from 20,000 to 45,000, and most typically of from 25,000 to 35,000, g/mol. In various embodiments, it is contemplated that one or more of the aforementioned values may be any value or range of values, both whole and fractional, within the aforementioned ranges and/or may vary by ±5%, ±10%, ±15%, ±20%, ±25%, ±30%, etc.

The polyalkylene glycol used to form the copolymer may be any known in the art including, but not limited to, polyethylene glycol, polypropylene glycol, etc. Typically, the polyalkylene glycol is further defined as polyethylene glycol. Polyethylene glycol has the following chemical structure wherein n is a number greater than one:

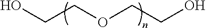

Typically, the polyethylene glycol used to form the copolymer has a number average molecular weight of from about 190 to 9,000 g/mol. In various embodiments, the polyethylene glycol is further defined as one or more of the following which are known in the art: PEG 200, PEG 300, PEG 400, PEG 540, PEG 600, PEG 900, PEG 1000, PEG 1450, PEG 1540, PEG 2000, PEG 3000, PEG 3350, PEG 4000, PEG 4600, PEG 6000, PEG 8000, and combinations thereof. Most typically, the polyethylene glycol has a number average molecular weight of about 6,000 g/mol. Accordingly, the copolymer of the polyvinyl alcohol and the polyethylene glycol typically has the following chemical structure:

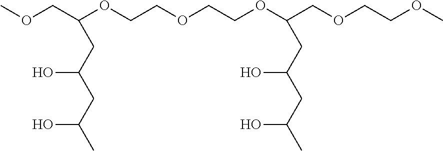

The copolymer is preferably formed without use of peroxide initiators, such as hydrogen peroxide or benzoyl peroxide. However, the invention is not limited in such a way. Typically, the copolymer does not require peroxide initiation for formation which thereby minimizes an amount of residual peroxide in the copolymer and thereby minimizing any oxidation and pre-mature decomposition of the encapsulated generator (20) that residual peroxides may otherwise cause.

In various embodiments, the copolymer includes from 10 to 40, from 20 to 40, from 20 to 30, or from 24 to 26, parts by weight of the polyalkylene glycol. In other embodiments, the copolymer includes from 50 to 90, from 60 to 80, from 70 to 80, or from 66 to 74, parts by weight of the polyvinyl alcohol. In an alternative embodiment, the copolymer includes approximately 25 parts by weight of the polyalkylene glycol and approximately 75 parts by weight of the polyvinyl alcohol, per 100 parts by weight of the copolymer. Of course, the copolymer is not limited to the aforementioned amounts and ranges. In various embodiments, it is contemplated that one or more of the aforementioned values may be any value or range of values, both whole and fractional, within the aforementioned ranges and/or may vary by ±5%, ±10%, ±15%, ±20%, ±25%, ±30%, etc.

Referring back to the protective layer (24) itself, the copolymer is typically present in an amount from 50 to 100, more typically from 60 to 99, still more typically from 80 to 99, even more typically from 90 to 99, and most typically from 95 to 99, parts by weight per 100 parts by weight of the protective layer (24). Of course, the invention is not limited to the aforementioned amounts and ranges. In various embodiments, it is contemplated that one or more of the aforementioned values may be any value or range of values, both whole and fractional, within the aforementioned ranges and/or may vary by ±5%, ±10%, ±15%, ±20%, ±25%, ±30%, etc.

In one embodiment, the protective layer (24) consists essentially of the copolymer of the polyvinyl alcohol and the polyalkylene glycol and is free of compounds that materially affect the basic and novel characteristics of the protective layer (24) such as other polymers and organic compounds. In another embodiment, the protective layer (24) consists essentially of the copolymer of the polyvinyl alcohol and the polyalkylene glycol and is free of compounds that materially affect the basic and novel characteristics of the protective layer (24) such as other polymers and organic compounds but may include free polyvinyl acetate. The protective layer (24) may consist essentially of the copolymer of the polyvinyl alcohol and the polyalkylene glycol and the one or more additives described above or consist essentially of the free polyvinyl acetate, the copolymer of the polyvinyl alcohol and the polyalkylene glycol, and the one or more additives described above. It is contemplated that the terminology “consists essentially of” may include weight percentages of the copolymer of polyvinyl alcohol and a polyalkylene glycol of 95, 96, 97, 98, 99, or greater, parts by weight per 100 parts by weight of the protective layer (24).

In still other embodiments, the protective layer (24) consists of the copolymer of the polyvinyl alcohol and the polyalkylene glycol or consists of free polyvinyl acetate and the copolymer of the polyvinyl alcohol and the polyalkylene glycol. In even further embodiments, the protective layer (24) consists of the copolymer of the polyvinyl alcohol and the polyalkylene glycol and the one or more additives described above or consists of free polyvinyl acetate, the copolymer of the polyvinyl alcohol and the polyalkylene glycol, and the one or more additives described above. Particularly suitable but non-limiting examples of the copolymer are commercially available from BASF Corporation under the trade names of Kollicoat®, Kollicoat® IR, Kollicoat® IR White, and Kollicoat® Protect. Accordingly, in various embodiments, the protective coating may consist of or consist essentially of one or more of these particularly suitable copolymers.

In other embodiments, the protective layer (24) further includes free polyvinyl alcohol, further consists essentially of the free polyvinyl alcohol and the copolymer of polyvinyl alcohol and a polyalkylene glycol, or further consists of the free polyvinyl alcohol (as in the embodiments described in detail above) and the copolymer of polyvinyl alcohol and a polyalkylene glycol. Typically, the terminology “free,” used when referring to free polyvinyl alcohol, refers to the polyvinyl alcohol being present as a discrete polymer of vinyl alcohol monomers without any co-polymerization with other monomers such as polyalkylene glycols. In some embodiments, the protective layer (24) includes from 30 to 80, from 40 to 70, from 50 to 70, or from 55 to 65, parts by weight of the copolymer of polyvinyl alcohol and polyalkylene (e.g. polyethylene) glycol and also from 20 to 70, from 30 to 60, from 30 to 50, or from 35 to 45, parts by weight of the free polyvinyl alcohol, per 100 parts by weight of the protective layer (24). The invention is not limited to the aforementioned amounts and ranges. In various embodiments, it is contemplated that one or more of the aforementioned values may be any value or range of values, both whole and fractional, within the aforementioned ranges and/or may vary by ±5%, ±10%, ±15%, ±20%, ±25%, ±30%, etc.

The protective layer (24) may also include a second copolymer that is different from the copolymer described above. In one embodiment, the second copolymer is a polyvinyl acetate dispersion. One non-limiting example of such a polyvinyl acetate dispersion is commercially available from BASF Corporation under the trade name Kollicoat® SR 30 D. This dispersion includes 27% polyvinyl acetate, 2.7% povidone, and 0.3% sodium lauryl sulfate and has a total solid content of 30%. In another embodiment, the second copolymer is a methacrylic acid-ethyl acrylate copolymer. One non-limiting example of such as copolymer is commercially available from BASF Corporation under the trade name of Kollicoat® MAE 30 DP. In yet another embodiment, the second copolymer is commercially available from BASF Corporation under the trade name of Kollicoat® MAE 100 P. It is also contemplated that the protective layer (24) may include polyvinylpyrrolidone (PVP).

The protective layer (24) may also include one or more additives that may be the same or different from the additives described above. The additives of the protective layer may be selected from the group of silicon dioxide, talc, titanium dioxide, fillers, tabletting and tablet die lubricants, stabilizers, dyes, anti-caking agents, desiccating fillings, pore forming agents, effervescing agents, and combinations thereof. In one embodiment, the additive of the protective layer is further defined as a blend of polyvinyl acetate and povidone such as Kollidon® SR which is commercially available from BASF Corporation. In various embodiments, the protective layer (24) includes from 0.1 to 30, from 1 to 20, or from 1 to 15, from 1 to 10, from 1to 5, from 1 to 3, from 1 to 2, from 0.1 to 10, from 0.1 to 5, from 0.1 to 2, or from 0.1 to 1, parts by weight of the additive per 100 parts by weight of the protective layer (24). In one embodiment, the protective layer (24) includes the additive in an amount of from 0.1 to 0.3 parts by weight per 100 parts by weight of the protective layer (24). In another embodiment, the protective layer includes of from 0.1 to 20, from 1 to 10, from 1 to 5, or from 1 to 3, parts by weight of talc. In a further embodiment, the protective layer includes of from 0.1 to 20, from 1 to 10, from 1 to 5, or from 1 to 2, parts by weight of titanium dioxide. In still other embodiments, the protective layer includes talc, titanium dioxide, kaolin, and/or combinations thereof. Further, the protective layer may include talc and titanium dioxide or kaolin and titanium dioxide. In yet another embodiment, the protective layer includes of from 0.1 to 2, from 0.1 to 1, from 0.1 to 0.5, or from 0.1 to 3, parts by weight of silicon dioxide. In various embodiments, it is contemplated that one or more of the aforementioned values may be any value or range of values, both whole and fractional, within the aforementioned ranges and/or may vary by ±5%, ±10%, ±15%, ±20%, ±25%, ±30%, etc.

The encapsulated generator (20) may also include a second protective layer (26) or a series of additional protective layers (not shown in the Figures). The second (26) and/or additional protective layers may be the same or may be different from the protective layer (24). In one embodiment, the second protective layer (26) includes a wax. In another embodiment, the second protective layer (26) includes one or more of the second copolymers described above.

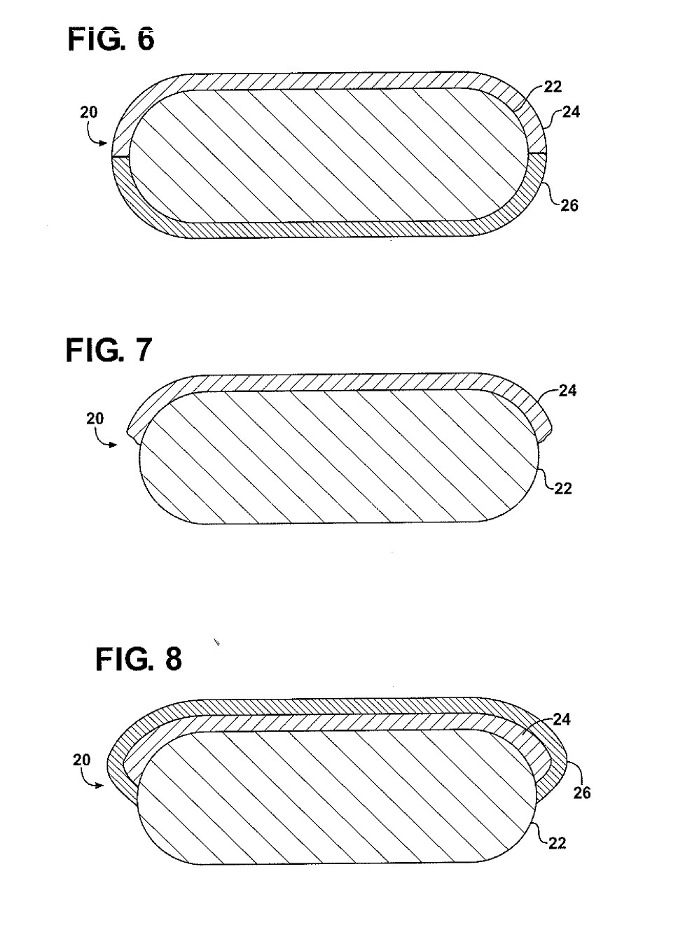

In various embodiments, the second protective layer (26) is typically disposed about at least a portion of the core particle (22) and either partially or completely covers the core particle (22) and the protective layer (24). In one embodiment, the second protective layer (26) completely encompasses the core particle (22) and the protective layer (24), as shown in FIGS. 3 and 5. In another embodiment, the second protective layer (26) partially encompasses the core particle (22) and the protective layer (24), as shown in FIG. 8. In yet another embodiment, the protective layer (24) is disposed about at least a portion of a first portion of the core particle (22) and the second protective layer (26) is disposed about at least a portion of a second portion of the core particle (22), as shown in FIG. 6.

As described above, the protective layer (24) is typically disposed on and in direct contact with the core particle (22). However, it is also contemplated that the second protective layer (26) may be disposed on and in direct contact with the core particle (22). In one embodiment (not shown in the Figures), the second protective layer (26) is disposed on and in direct contact with the core particle (22) while the protective layer (24) is disposed on and in direct contact with the second protective layer (26). Both the protective layer (24) and the second protective layer (26) may be disposed on each other and one or both may partially or entirely encompass each other and/or the core particle (22).

In various embodiments, the second protective layer (26) is typically present in an amount of from 0.1 to 20, more typically in an amount of from 3 to 15, even more typically present in an amount of from 3 to 5, parts by weight per 100 parts by weight of the core particle (22). In various embodiments, the second protective layer (26) is present in an amount of from 3 to 6, from 3 to 7, from 3 to 8, from 3 to 9, from 3 to 10, from 3 to 11, from 3 to 12, from 3 to 13, from 3 to 14, from 9 to 12, or from 9 to 15, parts by weight per 100 parts by weight of the core particle (22). Of course, the second protective layer (26) is not limited to the aforementioned amounts and ranges. In various embodiments, it is contemplated that one or more of the aforementioned values may be any value or range of values, both whole and fractional, within the aforementioned ranges and/or may vary by ±5%, ±10%, ±15%, ±20%, ±25%, ±30%, etc. The second protective layer (26) may have a varying or consistent thickness and may have any one or more of the thicknesses described above relative to the protective layer (24).

In typical embodiments, the protective layer (24) provides a moisture barrier for the core particle (22) which reduces permeability of water to the core particle (22) thereby enhancing both storage and shipping stability of the encapsulated generator (20) and extending shelf life. Typically, the encapsulated generator (20) produces less than 1 part by weight of chlorine dioxide per one million parts by weight of air during exposure to air at various temperatures, at various humidities, and for various times. Said differently, the encapsulated generator (20) is resistant to breakdown due to permeation of ambient humidity through the protective layer (24) and into the core particle (22) that would cause premature formation of chlorine dioxide and breakdown of the core particle (22). In various embodiments, the encapsulated generator (20) produces less than 1 part by weight of chlorine dioxide per one million parts by weight of air during exposure to air at temperatures of from 20° C. to 27° C. and at relative humidities of from 30 to 40 percent for a time of about 48 hours. Typically, this resistance to breakdown is evaluated visually through a lack of observation of cracking or splitting, of color change, and/or of effervescence of the encapsulated generator (20). This reduced permeability also increases ease and convenience of use due to an ability to expose the encapsulated generator (20) to a variety of temperatures and humidities for extended periods of time without the premature formation and release of chlorine dioxide.

In other embodiments, the encapsulated generator (20) produces less than 1 part by weight of chlorine dioxide per one million parts by weight of air during exposure to air at a various temperatures of from 25° C. to 70° C. and at a relative humidity of about 100 percent for about one hour. In one embodiment, the encapsulated generator (20) produces less than 1 part by weight of chlorine dioxide per one million parts by weight of air during exposure to air at a temperature of about 25° C. and at a relative humidity of about 100 percent for about one hour. In another embodiment, the encapsulated generator (20) produces less than 1 part by weight of chlorine dioxide per one million parts by weight of air during exposure to air at a temperature of about 40° C. and at a relative humidity of about 100 percent for about one hour. In still another embodiment, the encapsulated generator (20) produces less than 1 part by weight of chlorine dioxide per one million parts by weight of air during exposure to air at a temperature of about 70° C. and at a relative humidity of about 100 percent for about one hour. The generation of chlorine dioxide described immediately above is typically measured using a DraegerTubes® and methods known in the art. More specifically, the Draeger-Tubes® are typically glass vials that are filled with o-tolidine that reacts with chlorine dioxide to form a light green product that is visually observable and quantifiable.

In one embodiment, the encapsulated generator (20) produces less than 0.01 parts by weight of chlorine dioxide per one million parts by weight of air during exposure to air at a temperature of about 38° C. and a relative humidity of about 25 percent for about 550 minutes. In another embodiment, the encapsulated generator (20) produces less than 0.05 parts by weight of chlorine dioxide per one million parts by weight of air during exposure to air at a temperature of about 38° C. and a relative humidity of about 38 percent for about 75 minutes. In yet another embodiment, the encapsulated generator (20) produces less than 0.1 parts by weight of chlorine dioxide per one million parts by weight of air during exposure to air at a temperature of about 38° C. and a relative humidity of about 70 percent for about 38 minutes. In a further embodiment, the encapsulated generator (20) produces less than 0.3 parts by weight of chlorine dioxide per one million parts by weight of air during exposure to air at a temperature of about 38° C. and a relative humidity of about 100 percent for about 24 minutes.

The protective layer (24) typically allows the encapsulated generator (20) to dissolve in water and thus produce chlorine dioxide upon demand and under desired conditions. In another embodiment, the encapsulated generator (20) has a dissolution time of at least 90 minutes in water at a temperature of about 25° C. In a further embodiment, the encapsulated generator (20) has a dissolution time of at least 0.5 minutes in water at a temperature of about 99° C.

The protective layer (24) also typically improves the hardness and durability of the encapsulated generator (20) while simultaneously reducing friability during transport and use. This reduces shipping and handling costs, preserves the integrity of the encapsulated generator when sold, and minimizes costs associated with replacement of fractured product. In various embodiments, samples of the encapsulated generator (20) are rotated approximately 3,600 times and less than 10, more typically less than 5, still more typically less than 3, and most typically less than 1, percent of the samples crack or break, as observed visually. In one embodiment, none of the samples crack or break.

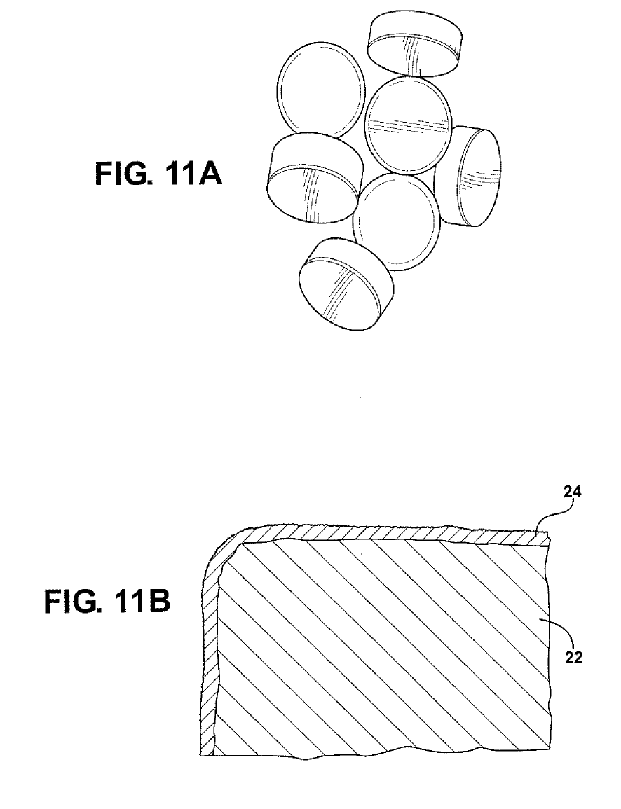

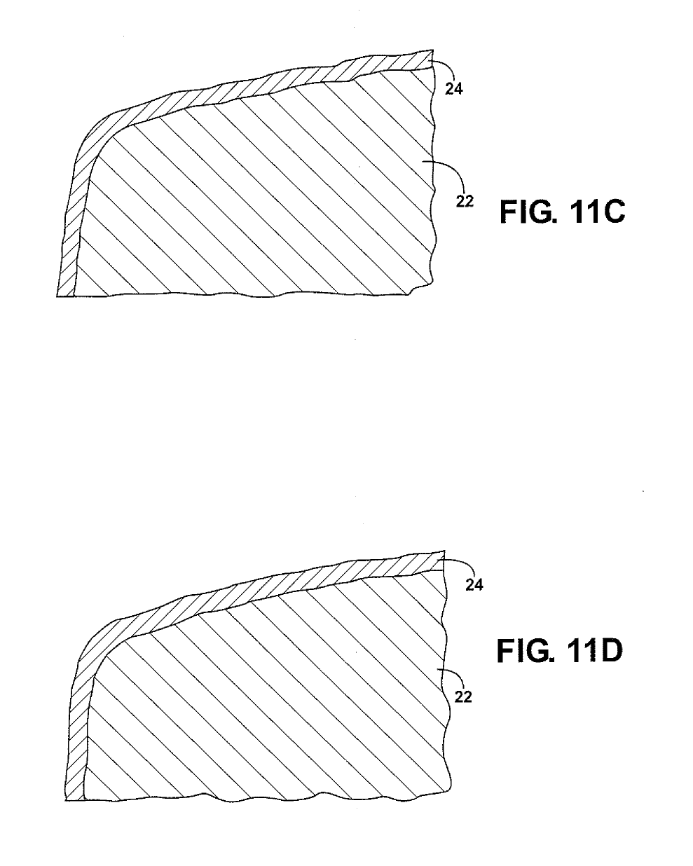

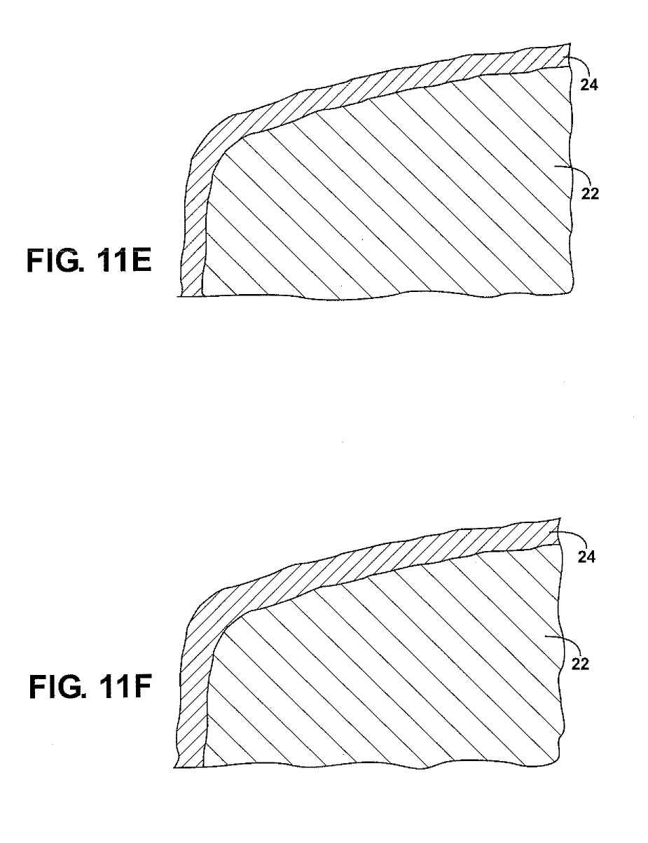

Furthermore, the protective layer (24) typically provides an excellent finish and glossy appearance to the encapsulated generator (20) thereby increasing marketability. As illustrated in FIGS. 11a, 11c, 11g, 11e, and 11i, the encapsulated generator (20) retains an excellent finish with differing amounts of the protective layer (24).

The encapsulated generator (20) is formed in a method that includes the step of forming the core particle (22) and disposing the protective layer (24) about the core particle (22). In one embodiment, the method further includes the step of dissolving the copolymer in water to form a solution. The step of disposing the protective layer may be further defined as spraying the solution onto the core particle (22). The step of spraying may be further defined as any type of spraying known in the art. In one embodiment, the step of spraying is further defined as pan coating. The pan coating of this invention typically involves manipulation of a variety of parameters including, but not limited to, relative humidity, coating room temperature, pan diameter, pan speed, pan depth, pan brim volume, pan load, shape and size of the core particle (22), baffle efficiency, number of spray guns, acceleration due to gravity, spray rate, inlet airflow, inlet temperature, air properties, exhaust temperature, atomizing air pressure, solution properties, gun-to-bed distance, nozzle type and size, and coating time. In the instant invention, one or more of these parameters may be adjusted and/or customized to dispose the protective layer (24) about the core particle (24).

In another embodiment, the method further includes the step of combining the metal chlorite and the solid acid to form a mixture. In this embodiment, the step of forming the core particle is typically further defined as compressing the mixture in a die to form the core particle. To form the core particle, the mixture is typically compressed at a pressure of from 1,000 to 100,000 lbs/in². Of course, the instant invention is not limited to this pressure and may include any known in the art. The core particle may be formed by other means including, but not limited to, granulating the mixture. In still another embodiment, the step of disposing is further defined as disposing from 3 to 15 parts by weight of the protective layer (24) onto the core particle (22). The method is not limited to this weight range and may include any one or more of the weight ranges described above. In various embodiments, it is contemplated that one or more of the aforementioned values may be any value or range of values, both whole and fractional, within the aforementioned ranges and/or may vary by ±5%, ±10%, ±15%, ±20%, ±25%, ±30%, etc.

The instant invention also provides a method of forming chlorine dioxide from the encapsulated generator (20). The method includes the step of forming the encapsulated generator (20) and the step of reacting the metal chlorine and the solid acid of the encapsulated generator (20) which forms the chlorine dioxide. The encapsulated generator may be formed by any method or steps described above. Similarly, the metal chlorite and the solid acid may react by any method, step, or mechanism described above. In one embodiment, the metal chlorite and the solid acid react when a user contacts the encapsulated generator (20) with water, such as liquid water or steam. This may occur through submersion in water, spraying with water, mixing with water, or exposure to ambient humidity. However, the instant invention is not limited to these specific steps. In another embodiment, the user generates the chlorine dioxide in a first vessel and then transfers the chlorine dioxide to a second vessel and/or substrate for further use.

The instant invention also provides a method of cleaning an environment using chlorine dioxide. The chlorine dioxide may be used as a biocide, germicide, and/or deodorizing agent to clean the environment. The environment may be further defined as a surface of a substrate including, but not limited to, plastics, papers, marble, granite, metals, ceramics, polymers, fabrics, textiles, carpets, dishes, housewares, appliances, toilets, sinks, floors, walls, ceilings, and the like. In various embodiments, such a substrate is present in residential settings or veterinary settings. Alternatively, such a substrate may be present in a commercial setting. The environment may be outdoors or indoors. In one embodiment, the environment is further defined as an industrial and institutional (I&I) environment such as a laundry environment. In another embodiment, the environment is further defined as an automatic dishwater (ADW) environment. In yet another embodiment, the environment is further defined as a cooling tower. In still another embodiment, the environment is further defined as a water supply, such as personal or municipal water supply. In one embodiment, the environment is further defined as non-potable water wherein the non-potable drinking water is cleaned with the chlorine dioxide to form potable drinking water. In still other embodiments, the environment is further defined as a bio-film sanitizer or a reverse osmosis water system. The environment may also be further defined as a recreational water system such as a swimming pool and/or spa.

In one embodiment, the environment is further defined as water and the step of forming the chlorine dioxide is further defined as exposing the encapsulated generator (20) to the water to form the chlorine dioxide in-situ, i.e., in the water that is used to form the chlorine dioxide. The water may be present in residential or commercial setting, be present indoors or outdoors, or present in combinations thereof. In another embodiment, the environment is further defined as a surface of the substrate and the step of forming the chlorine dioxide is further defined as forming the chlorine dioxide apart from the surface of the substrate. In this embodiment, the method further includes the step of applying the chlorine dioxide to the surface of the substrate. Typically, the chlorine dioxide is applied manually using paper, a sponge, or the like. Alternatively, the chlorine dioxide may be sprayed onto the surface of the substrate, mopped onto the surface, or allowed to soak on, or into, the surface, over a period of time. In various embodiments, the chlorine dioxide is applied to residential or commercial kitchen and/or bath surfaces.

### EXAMPLES

A series of Aseptrol® tablets that are commercially available from BASF Corporation are encapsulated and subsequently evaluated to determine a series of physical properties, as described in greater detail below. As is known in the art, Aseptrol® tablets are chlorine dioxide generators and include a metal chlorite and a solid acid.

### Examples of the Instant Invention

A first series of Aseptrol® tablets (Tablets I) are encapsulated according to the instant invention using Kollicoat® Protect, commercially available from BASF Corporation, as a protective layer. As is known in the art, Kollicoat® Protect is a copolymer including 75 wt % polyvinyl alcohol and 25 wt % polyethylene glycol units and having a molecular weight of approximately 45,000 Daltons. Kollicoat® Protect also includes free polyvinyl alcohol.

More specifically, the Tablets I are encapsulated with a mixture including approximately 12.5 wt % of Kollicoat® Protect, approximately 3 wt % of talc, approximately 1.5 wt % of titanium dioxide, and approximately 83 wt % of water. This mixture is typically formed by combining 750 grams of Kollicoat® Protect, 180 g of talc, 90 g of titanium dioxide, and 4.7 kg of water. The Aseptrol® tablets are encapsulated using a pan coating technique using an atomizing air pressure of about 50 psi, a pan to room pressure of about 0.2 bar, a pan speed of about 16 rpm, and the following additional parameters:

| | Inlet | Exhaust | Inlet Air | Pan Loaded | Spray |
|---|---|---|---|---|---|
| | Temp. | Temp | Pressure | in Water | Rate |
| Time | (° C.) | (° C.) | (psi) | (psi) | (ml/min) |
| Initial | 60 | 53.9 | 210 | 1.5 | 20 |
| 15 min | 62 | 48.5 | 211 | 1.5 | 20 |
| 30 min | 62 | 47.7 | 211 | 1.6 | 20 |
| 45 min | 62 | 47.5 | 212 | 1.6 | 20 |
| 60 min | 62 | 47.6 | 210 | 1.5 | 20 |
| 75 min | 62 | 47.4 | 208 | 1.6 | 20 |
| 90 min | 62 | 47.8 | 209 | 1.6 | 20 |
| 105 min | 62 | 48.1 | 208 | 1.6 | 30 |
| 120 min | 62 | 49.6 | 214 | 1.6 | 30 |
| 135 min | 68 | 48.0 | 212 | 1.6 | 30 |
| 150 min | 68 | 49.4 | 214 | 1.6 | 30 |
| 165 min | 68 | 49.0 | 214 | 1.6 | 30 |
| 180 min | 69 | 49.0 | 214 | 1.6 | 30 |
| 195 min | 66.5 | 49.6 | 214 | 1.6 | 30 |

The Tablets I include approximately 3 parts by weight of the Kollicoat® Protect protective layer per 100 parts by weight of the uncoated tablets. After encapsulation, the Tablets I are evaluated to determine a series of physical properties. The results of these evaluations are set forth in the Tables below.

A second series of Aseptrol® tablets (Tablets II) is also encapsulated according to the instant invention using Kollicoat® Protect. The Tablets II are formed using the same method described above. The Tablets II include approximately 5 to 8 parts by weight of the Kollicoat® Protect protective layer per 100 parts by weight of the uncoated tablets. After encapsulation, the Tablets II are evaluated to determine a series of physical properties. The results of these evaluations are set forth in the Tables below.

### Comparative Examples

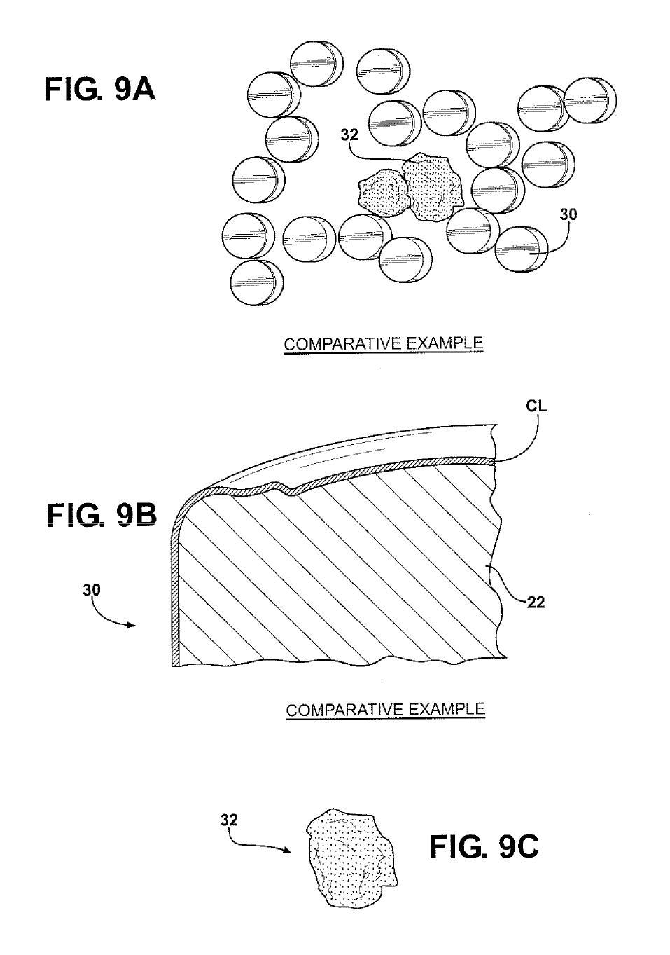

A comparative series of Aseptrol® tablets (Comparative Tablets I) is also encapsulated but not according to the instant invention. That is, no copolymer of polyvinyl alcohol and polyalkylene glycol is used to encapsulate the Comparative Tablets 1. More specifically, the Aseptrol® tablets are encapsulated using ethyl cellulose as a protective (comparative) layer (CL), as shown in FIG. 9B. The ethyl cellulose is applied to the tablets using a pan coating technique using an atomizing air pressure of about 50 psi, a pan to room pressure of about 0.2 bar, a pan speed of about 35 rpm, and the following additional parameters:

| | Inlet | Exhaust | Inlet Air | Pan Loaded | Spray |
|---|---|---|---|---|---|
| | Temp. | Temp | Pressure | in Water | Rate |
| Time | (° C.) | (° C.) | (psi) | (psi) | (ml/min) |
| Initial | 74.6 | 51.2 | 210 | 1.5 | 20 |
| 5 min | 74.5 | 51.5 | 211 | 1.5 | 20 |
| 10 min | 74.4 | 51.2 | 211 | 1.6 | 20 |
| 15 min | 74.3 | 51.4 | 212 | 1.6 | 20 |

The Comparative Tablets I include approximately 5 to 8 parts by weight of the ethyl cellulose protective layer per 100 parts by weight of the uncoated tablets. After encapsulation, the Comparative Tablets I are evaluated to determine a series of physical properties. The results of these evaluations are set forth in the Tables below.

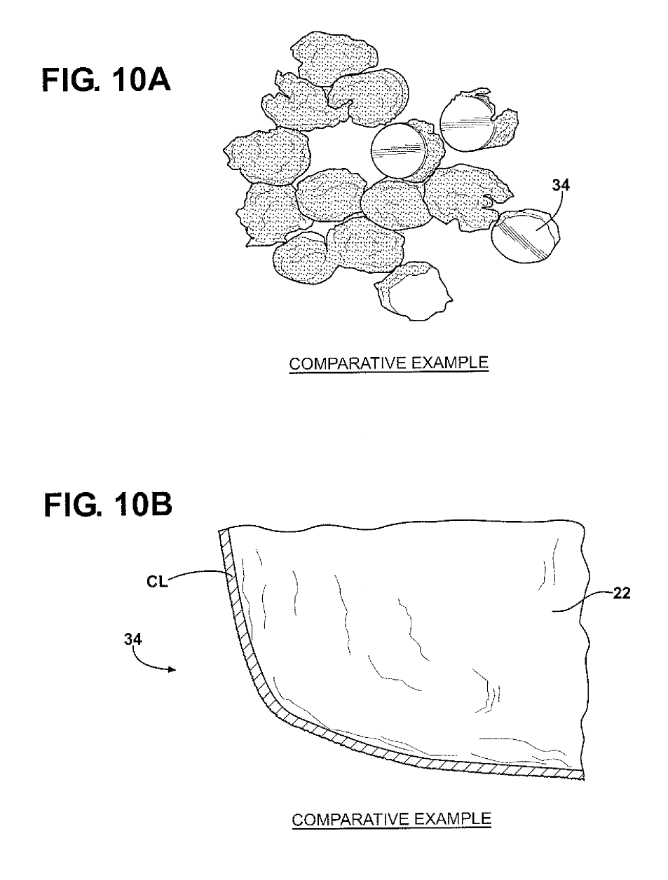

A second comparative series of Aseptrol® tablets (Comparative Tablets II) is also encapsulated but not according to the instant invention. To form the Comparative Tablets II, the Aseptrol® tablets are encapsulated using Opadry® II as a protective (comparative) layer (CL), as shown in FIG. 10B. As is known in the art, Opadry® II includes polyvinyl alcohol and is commercially available from Colorcon Inc. The Opadry® II is applied to the tablets according to the method described immediately above relative to the ethyl cellulose. After encapsulation, the Comparative Tablets II are evaluated to determine a series of physical properties. The results of these evaluations are set forth in the Tables below.

### Evaluation of Encapsulated Tablets

As first introduced above, the Tablets I and II and the Comparative Tablets I and II are evaluated to determine a series of physical properties. More specifically, the encapsulated tablets are evaluated to determine: (1) visual appearance/permeability of the encapsulated tablets, (2) chlorine dioxide generation of the encapsulated tablets measured using Draeger-Tubes®, (3) chlorine dioxide generation of the encapsulated tablets measured in a temperature controlled humidity chamber, (4) dissolution time of the encapsulated tablets, and (5) a propensity of the encapsulated tablets to fracture.

### Visual Appearance/Permeability

Visual appearance/permeability is determined after encapsulation by placing the Tablets on a bench top at room temperature and at approximately 35 percent humidity. To measure the visual appearance/permeability, the Tablets are visually observed for a time of up to 48 hours to determine if there is any color change and/or effervescence. A color change and/or effervescence indicates that ambient humidity has permeated the protective layer and has initiated generation of chlorine dioxide. The results of this evaluation are set forth in Table 1 below and are reported as an average of triplicate testing of approximately 20 tablets per test.

TABLE 1

| | | | Comparative | Comparative |
|---|---|---|---|---|
| | Tablets I | Tablets II | Tablets I | Tablets II |
| Color Change | None | None | Yes | Yes |
| Time | At Least 48 | At Least 48 | Immediate | 2-3 hours |
| | hrs | hrs | | |
| Effervescence | None | None | Yes | Yes |
| Time | At Least 48 | At Least 48 | Immediate | 2-3 hours |
| | hrs | hrs | | |

### Chlorine Dioxide Generation Measured Using Draeger-Tubes®

Chlorine dioxide generation of the Tablets is measured using Draeger-Tubes®. Draeger-Tubes® measure a quantity of chlorine dioxide that is trapped in a finite space. The Draeger-Tubes® utilized herein are glass vials that are filled with o-tolidine that reacts with chlorine dioxide to form a light green product that is visually observable. More specifically, a calibrated 100 ml sample of air is drawn through the Tubes with a bellows pump. If the chlorine dioxide is present, the o-tolidine in the Tubes changes color and the length of the color change typically indicates the measured concentration. The generation of chlorine dioxide is measured with the Draeger-Tubes® at three different temperatures of 25° C., 40° C., and 75° C., all at a humidity of 100 percent, after a time of 60 minutes. The results of these evaluations are set forth in Table 2 below as approximate concentration in parts per million and are reported as an average of triplicate testing of approximately 20 tablets per test. The minimum detection threshold of the Draeger-Tubes® is 0.05 ppm. Accordingly, measurements of less than 0.05 ppm may be zero but are limited by the minimum detection threshold.

TABLE 2

| | | | Comparative | Comparative |
|---|---|---|---|---|
| | Tablets I | Tablets II | Tablets I | Tablets II |
| 25° C. | <0.05 ppm | <0.05 ppm | At least 5.0 ppm | At least 5.0 ppm |
| 40° C. | <0.05 ppm | <0.05 ppm | At least 5.0 ppm | At least 5.0 ppm |
| 70° C. | 0.6 ppm | 0.6 ppm | At least 5.0 ppm | At least 5.0 ppm |

### Chlorine Dioxide Generation Measured Using Temperature Controlled Humidity Chamber

A time taken for the Tablets to break down and generate chlorine dioxide is also measured using a temperature controlled humidity chamber. In the humidity controlled chamber, samples of the Tablets are independently exposed to four different levels of humidity (25%, 40%, 75%, and 100%) at 38° C. The generation of chlorine dioxide resulting from this exposure is determined using DraegerTubes® and once a 0.05 ppm threshold is reached, the time of tablet breakdown is recorded. The results of these evaluations are set forth in Table 3 below in minutes and are reported as an average of triplicate testing of approximately 20 tablets per test.

TABLE 3

| | | | Comparative | Comparative |
|---|---|---|---|---|
| | Tablets I | Tablets II | Tablets I | Tablets II |
| 25% | 552 min | 552 min | 0.6 min | 0.6 min |
| Humidity | | | | |
| 40% | 75 min | 75 min | Immediate | Immediate |
| Humidity | | | | |
| 70% | 38 min | 38 min | Immediate | Immediate |
| Humidity | | | | |
| 100% | 24 min | 24 min | Immediate | Immediate |
| Humidity | | | | |

### Dissolution Time of Encapsulated Tablets

Dissolution time of the Tablets is measured through visual inspection in glass vials in tap water at both 25° C. and 99° C. More specifically, the Tablets are submersed in 500 ml of the tap water at the different temperatures and are observed to determine a length of time until complete dissolution is achieved. Complete dissolution is reached when the water is transparent according to visual evaluation. The results of these evaluations are set forth in Table 4 below in minutes and are reported as an average of triplicate testing of approximately 20 tablets per test.

TABLE 4

| | | | Comparative | Comparative |
|---|---|---|---|---|
| | Tablets I | Tablets II | Tablets I | Tablets II |
| 25° C. | 93 min | 93 min | 32 min | Immediate |
| 99° C. | 0.5 min | 0.5 min | Immediate | Immediate |

### Propensity of Encapsulated Tablets to Fracture

The propensity for the Tablets to fracture is also measured. This evaluation is designed to mimic 2.5 hours of transportation time of the tablets between a distribution center and a retailer or customer. More specifically, samples of the Tablets are independently placed in both glass and plastic bottles which are subsequently rotated approximately 3,600 revolutions at room temperature. After rotation, the Tablets are visually observed to determine a percentage of the Tablets that cracked. The results of these evaluations are set forth in Table 5 below as percentage fracture and are reported as an average of 5 independent tests of approximately 20 tablets per test.

TABLE 5

| | | | Comparative | Comparative |
|---|---|---|---|---|
| | Tablets I | Tablets II | Tablets I | Tablets II |
| Glass | 0 | 0 | 10 | 15 |
| Plastic | 0 | 0 | 20 | 25 |

The data set forth above clearly indicates that the Tablets I and II of the instant invention out-perform the Comparative Tablets I and II in each of the aforementioned tests. The protective layer of the instant invention which, in these embodiments is Kollicoat® Protect, provides protection to the tablets from both ambient and elevated humidity while still allowing controlled (i.e., non-premature) dissolution of the tablets. The protective layer also provides physical protection to the tablets and minimizes/prevents their fracturing in transport.

More specifically, the visual appearance/permeability evaluations demonstrate that the encapsulated tablets of this invention (Tablets I and II) can be exposed to ambient humidity without breaking down. This property is advantageous because it allows the tablets to have a greatly extended shelf life and increases ease and convenience of use by the end consumer. Moreover, this ability to withstand ambient humidity minimizes and possibly prevents premature formation of chlorine dioxide thereby increasing the safety of using chlorine dioxide generators.

The evaluations of chlorine dioxide generation using both the Draeger-Tubes® and the humidity controlled chamber also demonstrate that the encapsulated tablets of this invention have an extended ability to withstand elevated heat and humidity. As described above, this property is advantageous because it allows the tablets to have a greatly extended shelf life and increases ease and convenience of use by the end consumer. Moreover, this ability minimizes and possibly prevents premature formation of chlorine dioxide thereby increasing the safety of using chlorine dioxide generators.

The evaluations of dissolution time demonstrate that the encapsulated tablets of this invention (Tablets I and II) are protected from premature dissolution and premature formation of chlorine dioxide as compared with the Comparative Tablets I and II. More specifically, these evaluations demonstrate that even with protection from heat and humidity, as described above, the encapsulated tablets of this invention still function as desired and still are useable as chlorine dioxide generators. In fact, these evaluations further demonstrate the increased shelf life, ease and convenience of use, and increased safety achieved using the instant invention.

The evaluations of tablet fracturing demonstrate that that the encapsulated tablets of this invention (Tablets I and II) are physically protected from damage during transportation as compared with the Comparative Tablets I and II. This property is advantageous because it increases product quality and consumer satisfaction while decreasing replacement and reimbursement costs associated with broken or damaged tablets. This property also further increases the safety of using chlorine dioxide generators by reducing a chance that a fractured tablet might premature generate chlorine dioxide.

Importantly, the Tablets I include approximately 3 parts by weight of the Kollicoat® Protect per 100 parts by weight of the uncoated tablets. Conversely, the Tablets II and Comparative Tablets I and II includes approximately 2-3 times more, by weight (5-8 parts by weight) of the protective layer. This difference in coating weight further magnifies the advantages associated with this invention. In other words, the instant invention not only provides the Tablets with superior properties but does so with use of less material. This allows less material to be used thereby reducing production and shipping costs and reducing production times.

### Additional Examples of the Instant Invention

In addition to the aforementioned evaluations, five additional series of Aseptrol® tablets (Tablets III, IV, V, VI, and VII) are encapsulated according to the instant invention using Kollicoat® Protect. These Tablets are encapsulated using the same method as described above relative to Tablets I and II. The Tablets III-VII include approximately 9, 10, 12, 12.5, and 15 parts by weight of the Kollicoat Protect protective layer per 100 parts by weight of the uncoated tablets, respectively. Evaluation of Tablets III, IV, V, VI, and VII:

After encapsulation, the Tablets III-VII are visually examined to determine surface morphology and to detect any surface abnormalities. The results of the visual examination of Tablets III-VII are represented in FIGS. 11a, 11c, 11e, 11g, and 11i, respectively. In addition, cross-sections of the Tablets III-VII are prepared and examined under 50× light magnification to determine whether any breakdown of the protective layer occurs. The cross-sections of Tablets III-VII and the results of the examination under 50× light magnification are represented in FIGS. 11b, 11d, 11f, 11h, and 11j, respectively. The aforementioned Figures illustrate that even at high coating weights (i.e., at 9, 10, 12, 12.5, and 15 wt % of the protective layers), the Tablets III-VII do not suffer from surface breakdown or deformation. These results indicate that the instant invention can be effectively used in specialized applications, such as time release applications, wherein high coating weights are required.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

1. An encapsulated chlorine dioxide generator comprising:
A. a core particle comprising;
1. a metal chlorite, and
2. a solid acid; and
B. a protective layer disposed about at least a portion of said core particle and comprising a copolymer of polyvinyl alcohol and a polyalkylene glycol.

2. An encapsulated chlorine dioxide generator as set forth in claim 1 wherein said polyalkylene glycol is further defined as polyethylene glycol.

3. An encapsulated chlorine dioxide generator as set forth in claim 2 wherein said protective layer consists essentially of said copolymer of said polyvinyl alcohol and said polyethylene glycol.

4. An encapsulated chlorine dioxide generator as set forth in claim 1 wherein said protective layer has a thickness of from 85 to 210 micrometers.

5. An encapsulated chlorine dioxide generator as set forth in claim 1 wherein said protective layer further comprises free polyvinyl alcohol.

6. An encapsulated chlorine dioxide generator as set forth in claim 5 wherein said protective layer is present in an amount of from 1 to 15 parts by weight per 100 parts by weight of said core particle.

7. An encapsulated chlorine dioxide generator as set forth in claim 5 wherein said protective layer is present in an amount of from 3 to 5 parts by weight per 100 parts by weight of said core particle.

8. An encapsulated chlorine dioxide generator as set forth in claim 7 which produces less than 1 part by weight of chlorine dioxide per one million parts by weight of air during exposure to air at a temperature of from 20° C. to 27° C. and a relative humidity of from 30 to 40 percent for about 48 hours.

9. An encapsulated chlorine dioxide generator as set forth in claim 7 which produces less than 1 part by weight of chlorine dioxide per one million parts by weight of air during exposure to air at a temperature of from 25° C. to 70° C. and a relative humidity of about 100 percent for about one hour.

10. An encapsulated chlorine dioxide generator as set forth in claim 7 which produces less than 0.01 parts by weight of chlorine dioxide per one million parts by weight of air during exposure to air at a temperature of about 38° C. and a relative humidity of about 25 percent for about 550 minutes.

11. An encapsulated chlorine dioxide generator as set forth in claim 7 which has a dissolution time of at least 90 minutes in water at a temperature of about 25° C.

12. A method of forming an encapsulated chlorine dioxide generator that comprises a core particle including a metal chlorite and a solid acid, and a protective layer that is disposed about at least a portion of the core particle, said method comprising the steps of:
A. forming the core particle including the metal chlorite and the solid acid; and
B. disposing the protective layer comprising a copolymer of polyvinyl alcohol and a polyalkylene glycol about the core particle.

13. A method as set forth in claim 12 further comprising the step of dissolving the copolymer in water to form a solution and wherein the step of disposing the protective layer about the core particle is further defined as spraying the solution onto the core particle.

14. A method as set forth in claim 13 wherein the step of spraying is further defined as pan coating.

15. A method as set forth in claim 12 wherein the step of disposing is further defined as disposing from 1 to 15 parts by weight of the protective layer onto the core particle per 100 parts by weight of the core particle.

16. A method of cleaning an environment using chlorine dioxide, said method comprising the steps of:
A. providing an encapsulated chlorine dioxide generator comprising;
1. a core particle comprising a metal chlorite and a solid acid source, and
2. a protective layer disposed about at least a portion of the core particle and comprising a copolymer of polyvinyl alcohol and a polyalkylene glycol; and
B. forming chlorine dioxide from the encapsulated chlorine dioxide generator to clean the environment.

17. A method as set forth in claim 16 wherein the environment is further defined as water and the step of forming the chlorine dioxide is further defined as exposing the encapsulated chlorine dioxide generator to the water to form the chlorine dioxide in-situ.

18. A method as set forth in claim 16 wherein the environment is further defined as a surface of a substrate, wherein the step of forming the chlorine dioxide is further defined as forming the chlorine dioxide apart from the surface of the substrate, and wherein the method further comprises the step of applying the chlorine dioxide to the surface of the substrate.

19. A method as set forth in claim 16 wherein the polyalkylene glycol is further defined as polyethylene glycol.

20. A method as set forth in claim 19 wherein the protective layer consists essentially of the copolymer of the polyvinyl alcohol and the polyethylene glycol.
